(19) United States
(12) Patent Application Publication
(10) Pub. No.: US 2024/0346468 A1
(43) Pub. Date: Oct. 17, 2024

(54) METHODS AND SYSTEMS FOR SECURE TRANSFER OF PAYMENT PLANS

(71) Applicant: Visa International Service Association, San Francisco, CA (US)

(72) Inventors: Zoriana ADAMOVYCH, Dubai (AE); Viktoriia SAFRONOVA, Prague (CZ); Aliaa Ahmed Abdelhamid IBRAHIM SHAFIE, Alexandria (EG)

(73) Assignee: Visa International Service Association, San Francisco, CA (US)

(21) Appl. No.: 18/298,945

(22) Filed: Apr. 11, 2023

(51) Int. Cl. G06Q 20/10; G06Q 20/24; G06Q 20/40; G06Q 20/42

(52) U.S. Cl. CPC G06Q 20/10; G06Q 20/24; G06Q 20/4014; G06Q 20/42

(57) ABSTRACT

A computer implemented method of securely transferring at least one repayment obligation associated with a payment plan set for a first user to a second user includes receiving a transfer request from a first user device, associated with the first user, to transfer the at least one repayment obligation to the second user, wherein the transfer request includes a payment plan account identifier associated with the second user. The method includes pushing a confirmation request to a second user device, associated with the second user, to confirm acceptance of a transfer of the at least one repayment obligation, wherein the confirmation request comprises an identifier associated with the first user. The method includes receiving a confirmation, from the second user device, of the acceptance of the transfer of the at least one repayment obligation, and updating a payment status associated with the payment plan to a transferred status.

### TECHNICAL FIELD

At least some aspects of the present disclosure relate to improving payment plans involving purchases initiated between a user and a merchant using a credential associated with the payment plan, and more particularly, to improving flexibility of managing the enrollment of users participating in a payment plan.

### SUMMARY

In one aspect, a computer implemented method of securely transferring at least one repayment obligation associated with a payment plan set for a first user to a second user is provided. The method includes receiving, by an issuer system, a transfer request from a first user device, associated with the first user, to transfer the at least one repayment obligation to the second user, wherein the transfer request comprises a payment plan account identifier associated with the second user. The method further includes pushing, by the issuer system, a confirmation request to a second user device, associated with the second user, to confirm acceptance of a transfer of the at least one repayment obligation, wherein the confirmation request comprises an identifier associated with the first user. The method further includes receiving, by the issuer system, a confirmation, from the second user device, of the acceptance of the transfer of the at least one repayment obligation, and updating, by the issuer system, a payment status associated with the payment plan to a transferred status.

In one aspect, a computer implemented method of securely transferring at least one repayment obligation associated with a payment plan set for a first user to a second user is provided. The method includes receiving, by an issuer system, a transmission, from a first user device, indicative of at least one of a repayment method selection associated with the payment plan or a repayment schedule selection associated with the payment plan, and an account identifier associated with the second user. The method further includes pushing, by the issuer system, an approval request to a second user device, associated with the second user, to secure an approval of the payment plan, wherein the approval request comprises an account identifier associated with the first user. The method further includes receiving, by the issuer system, an indication, from the second user device, of the approval of the payment plan, and sending, by the issuer system, based on receiving the indication of the approval of the payment plan, a request to a payment network to implement the payment plan. The method further includes assigning, by the issuer system, an active status to the payment plan, receiving, by the issuer system, an alert, from the payment network, indicative of a failure to satisfy the at least one repayment obligation by the first user, and transferring, by the issuer system, the at least one repayment obligation to the second user, based on receiving the alert.

In one aspect, a computer implemented method of securely distributing at least one repayment obligation associated with a payment plan between multiple users is provides. The method includes receiving, by an issuer system, a transmission, from a first user device, indicative of a set of repayment details associated with the payment plan, and an account identifier associated with a second user. The method further includes pushing, by the issuer system, an acceptance request to a second user device, associated with the second user, to secure an acceptance by the second user to participate in the payment plan, and the set of repayment details associated therewith. The method further includes receiving, by the issuer system, a confirmation, from the second user device, indicative of the acceptance, by the second user, to participate in the payment plan. The method further includes sending, by the issuer system, based on receiving the confirmation from the second user device, a request to a payment network to generate a payment plan identifier associated with the payment plan and a first credential associated with the payment plan identifier, receiving, by the issuer system, the first credential from the payment network, and sending, by the issuer system, the first credential to the first user device.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrate aspects of concepts that include the claimed disclosure and explain various principles and advantages of those aspects.

The systems and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates a payment network environment 100 in which an issuer system can be configured to securely manage a payment plan, according to at least one aspect of the present disclosure.

FIG. 2 is a logic flow diagram for securely transferring at least one repayment obligation associated with a payment plan set for a first user to a second user, according to at least one aspect of the present disclosure.

FIG. 3 is a logic flow diagram for securely transferring at least one repayment obligation associated with a payment plan set for a first user to a second user, according to at least one aspect of the present disclosure.

FIG. 4 is a swimlane diagram illustrating a method for securely distributing at least one repayment obligation among multiple users, according to at least one aspect of the present disclosure.

FIG. 5 presents a block diagram of a computer apparatus, according to at least aspect of the present disclosure.

FIG. 6 is a diagrammatic representation of an example system that includes a host machine within which a set of instructions to perform any one or more of the methodologies discussed herein may be executed, according to at least aspect of the present disclosure.

### DESCRIPTION

The following disclosure may provide exemplary systems, devices, and methods for conducting a financial transaction and related activities. Although reference may be made to such financial transactions in the examples provided below, aspects are not so limited. That is, the systems, methods, and apparatuses may be utilized for any suitable purpose.

Various forms of payment plans have been developed to enable a transaction between a user and a merchant, thereby completing a purchase of goods, without requiring the user to pay the entire transaction amount at the time of purchase. For example, a user may elect to enroll in a Buy Now Pay Later (“BNPL”) plan offered and managed by an issuer system, wherein repayment obligations of the user to the issuer may be defined by the terms and conditions of the BNPL plan including repayment schedule, repayment method, loan amounts and/or interest rates. The issuer may subsequently provide a credential, associated with a user identifier and/or the BNPL plan, to the user for completing a transaction with a merchant. However, currently available payment plans and the organization of the issuer therein may not provide enough flexibility during the repayment period to ensure a fulfilment of repayment obligations. For example, users may encounter unforeseen financial hardships, especially during periods of large scale economic downturns, thereby overly straining the resources of the user and/or the issuer should the user fail to meet the terms and conditions of the payment plan. Enlisting a third party for financial assistance outside of an issuer managed platform may expose sensitive information associated with the user and/or the third party, and/or may not satisfy repayment obligations in a timely manner. Accordingly, there is a need for systems and methods for securely implementing and/or managing payment plans while providing flexibility therein.

As used herein, the term “payment plan” may include any short-term financial solutions providing scheduled extended repayment options or installments to consumers or users for future repayment of an original transaction authorized and/or funded by an administering entity, such as an issuer. The payment plan may include loans which may include associated terms and conditions such as interest rates and frequency of repayment. Payment plans may be managed by a single entity, such as an issuer, and facilitated by a payment network which may provide credentials or tokens to users uniquely associated with the payment plan and which can be redeemed at participating merchants. One illustrative non-limiting example of a payment plan is “Buy Now Pay Later” (BNPL), which is operated by Visa, Inc.

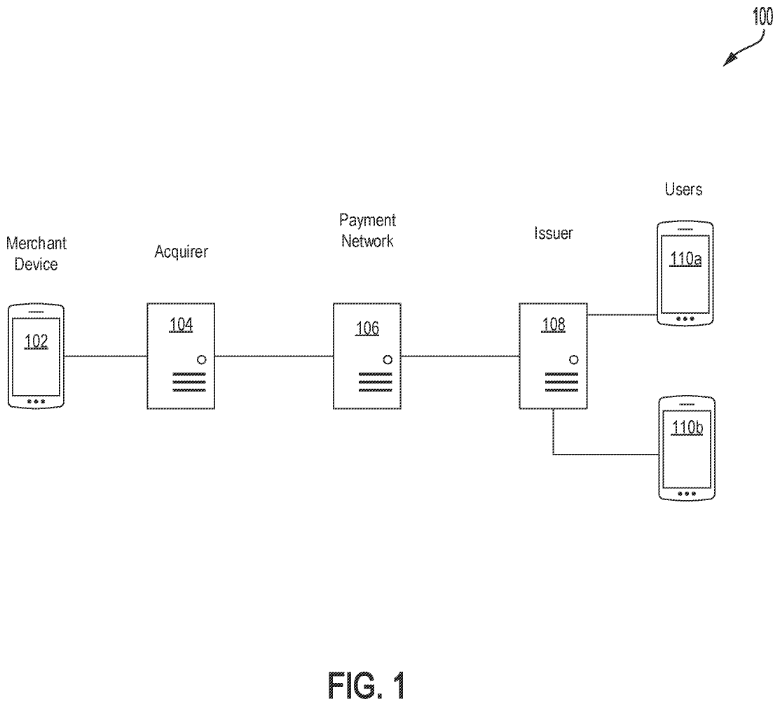

FIG. 1 illustrates a payment network environment 100 in which an issuer system 108 can be configured to securely manage a payment plan, according to at least one non-limiting aspect of the present disclosure. The payment network environment 100 includes a first user device 110a associated with a first user, a second user device 110b associated with a second user, a payment network system 106, an acquirer system 104 and a merchant system 102 associated with a merchant.

As used herein, the term “system” may refer to one or more computing devices or combinations of computing devices (e.g., processors, servers, client devices, software applications, components of such, and/or the like).

An “issuer” can include a payment account issuer. The payment account (which may be associated with one or more payment devices) may refer to any suitable payment account (e.g. credit card account, a checking account, a savings account, a merchant account assigned to a consumer, or a prepaid account), an employment account, an identification account, an enrollment account (e.g. a student account), etc.

As used herein, a “user” may include an individual or a user that may be associated with one or more personal accounts and/or consumer devices. The user may also be referred to as a cardholder, account holder, or consumer. A user may initiate, via an issuer app on a user device, a request to an issuer to enroll in a payment plan provided thereby.

The terms “client device” and “user device” refer to any electronic device that is configured to communicate with one or more servers or remote devices and/or systems. A client device or a user device may include a mobile device, a network-enabled appliance (e.g., a network-enabled television, refrigerator, thermostat, and/or the like), a computer, a POS system, and/or any other device or system capable of communicating with a network. A client device may further include a desktop computer, laptop computer, mobile computer (e.g., smartphone), a wearable computer (e.g., a watch, pair of glasses, lens, clothing, and/or the like), a cellular phone, a network-enabled appliance (e.g., a network-enabled television, refrigerator, thermostat, and/or the like), a point of sale (POS) system, and/or any other device, system, and/or software application configured to communicate with a remote device or system.

As used herein, the term “merchant” may refer to one or more individuals or entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein “merchant system” may refer to one or more computer systems operated by or on behalf of a merchant, such as a server computer executing one or more software applications.

A “payment network” may refer to an electronic payment system used to accept, transmit, or process transactions made by payment devices for money, goods, or services. The payment network may transfer information and funds among issuers, acquirers, merchants, and payment device users.

Still referring to FIG. 1, the issuer system 108 is in two way communication with each of the first user device 110a, the second user device 110b, and the payment network system 106. Each of the user devices 110a and 110b may be identified on the issuer system 108 by a respective account identifier associated with a user thereof and communicate with the issuer system 108 via an issuer provided interface or application over a respective communication channel. Further, each of the account identifiers may include payment credentials.

As used herein, the term “communication” and “communicate” may refer to the reception, receipt, transmission, transfer, provision, and/or the like of information (e.g., data, signals, messages, instructions, calls, commands, and/or the like). A communication may use a direct or indirect connection and may be wired and/or wireless in nature. As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. For example, a first unit may be in communication with a second unit even though the first unit passively receives data and does not actively transmit data to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting embodiments, a message may refer to a packet (e.g., a data packet, a network packet, and/or the like) that includes data. It will be appreciated that numerous other arrangements are possible.

A “communication channel” may refer to any suitable path for communication between two or more entities. Suitable communications channels may be present directly between two entities such as a payment processing network and a merchant or issuer computer, or may include a number of different entities. Any suitable communications protocols may be used for generating a communications channel. A communication channel may in some instances comprise a “secure communication channel” or a “tunnel,” either of which may be established in any known manner, including the use of mutual authentication and a session key and establishment of a secure communications session. However, any method of creating a secure communication channel may be used, and communication channels may be wired or wireless, as well as long-range, short-range, or medium-range. By establishing a secure channel, sensitive information related to a payment device (such as account number, CVV values, expiration dates, etc.) may be securely transmitted between the two entities to facilitate a transaction.

An “interface” may include any software module configured to process communications. For example, an interface may be configured to receive, process, and respond to a particular entity in a particular communication format. Further, a computer, device, and/or system may include any number of interfaces depending on the functionality and capabilities of the computer, device, and/or system. In some embodiments, an interface may include an application programming interface (API) or other communication format or protocol that may be provided to third parties or to a particular entity to allow for communication with a device. Additionally, an interface may be designed based on functionality, a designated entity configured to communicate with, or any other variable. For example, an interface may be configured to allow for a system to field a particular request or may be configured to allow a particular entity to communicate with the system.

An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.).

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities.

The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “account identifier” may refer to one or more types of identifiers associated with an account (e.g., a unique identifier of an account, an account number, a PAN, a card number, a payment card number, a token, and/or the like) of a user. In some non-limiting embodiments, an issuer may provide an account identifier (e.g., a PAN, a token, a globally unique identifier (GUID), a universally unique identifier (UUID), and/or the like) to a user that uniquely identifies one or more accounts associated with that user. In some non-limiting embodiments, an account identifier may be embodied on a payment device (e.g., a portable financial instrument, a payment card, a credit card, a debit card, and/or the like) and/or may be electronic information communicated to the user that the user may use for electronic payment transactions. In some non-limiting embodiments, an account identifier may be an original account identifier, where the original account identifier was provided to a user at the creation of the account associated with the account identifier. In some non-limiting embodiments, the account identifier may be an account identifier (e.g., a supplemental account identifier) that is provided to a user after the original account identifier was provided to the user. For example, if the original account identifier is forgotten by the user, stolen from the user, and/or the like, a supplemental account identifier may be provided to the user. In some non-limiting embodiments, an account identifier may be directly or indirectly associated with an issuer such that an account identifier may be a token that maps to a PAN or other type of identifier. Account identifiers may be alphanumeric, any combination of characters and/or symbols, and/or the like.

Still referring to FIG. 1, the payment network system 106 is in communication with the acquirer system 104, and the acquirer system 104 is in communication with a merchant device 102 associated with the merchant 102. Other configurations of the issuer system 108 are contemplated by the present disclosure. For example, in some implementations, the issuer system 108 may be in communication with one or more user devices in addition to the first user device 110a and the second user device 110b.

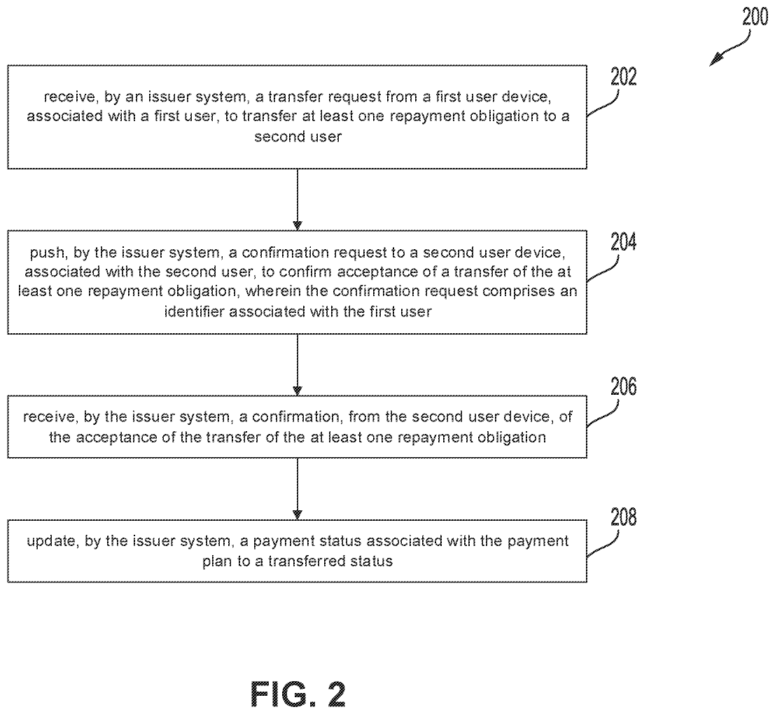

FIG. 2 is a flow diagram of a method 200 for securely transferring at least one repayment obligation associated with a payment plan set for a first user to a second user, according to at least one aspect of the present disclosure. In some aspects, the method 200 may be implemented in a transfer of a preexisting payment plan, such as a BNPL plan, via an issuer API. The method 200 can be executed by the issuer system 108 described above with respect to FIG. 1. To better describe various aspects of the method 200, an illustrative example of the inputs received and outputs generated by the issuer system 108 in the method 200 are discussed below. The method 200 is not limited to these example inputs and outputs.

Referring primarily to FIGS. 1-2, according to the method 200, the issuer system 108 receives 202 a transfer request from a first user device 110a, associated with a first user, to transfer at least one repayment obligation to a second user. The transfer request includes a payment plan account identifier, which may include user information and/or a credential, associated with the second user and may be received via an issuer provided API. In various aspects, the payment plan account identifier associated with the second user may include an issuer platform user name associated with the second user.

A “credential” may be any suitable information that serves as reliable evidence of worth, ownership, identity, or authority. A credential may be a string of numbers, letters, or any other suitable characters that may be present or contained in any object or document that can serve as confirmation. Examples of credentials include value credentials, identification cards, certified documents, access cards, passcodes and other login information, etc.

A “value credential” may be information associated with worth. Examples of value credentials include payment credentials, coupon identifiers, information needed to obtain a promotional offer, etc.

As used herein, the term “account credential,” “account number,” or “payment credential” may refer to any suitable information associated with an account (e.g. a payment account and/or payment device associated with the account). Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc.

Still referring primarily to FIGS. 1-2, according to the method 200, the issuer system 108, based on the transfer request from the first user device 110a, pushes 204 a confirmation request to a second user device 110b, associated with the second user to confirm acceptance of a transfer of the at least one repayment obligation. As used herein, the term “push” may include a transmission of data, such as a message or a request, specific to an application or an API such that the pushed data is viewable in the application accessible on a device, such as a user device. In various aspects, the confirmation request may include an identifier associated with the first user. In some embodiments, the confirmation request may include an option to select payment plan details associated with satisfying the at least one repayment obligation. For example, the confirmation request, pushed 204 by the issuer 108 to the second user device 110b, may require a selection and/or modification of payment plan details, including a repayment schedule and/or a payment method, associated with the new payment plan to be accepted by the second user. The payment method can include payment credentials and/or associated tokens which can later be stored in the payment network system 106, accessible by a funds transfer API for a future transaction or recurring payment, such as card-on-file transaction. In other embodiments, the confirmation request to confirm acceptance of a transfer of the at least one repayment obligation and a request to select payment plan details and/or confirm a repayment schedule may be pushed by the issuer system 108 to the second user device 110b as separate transmissions as discussed in further detail below.

“Payment credentials” may include any suitable information associated with an account (e.g. a payment account and/or payment device associated with the account). Such information may be directly related to the account or may be derived from information related to the account. Examples of account information may include a PAN (primary account number or “account number”), user name, expiration date, CVV (card verification value), dCVV (dynamic card verification value), CW2 (card verification value 2), CVC3 card verification values, etc. CW2 is generally understood to be a static verification value associated with a payment device. CW2 values are generally visible to a user (e.g., a consumer), whereas CW and dCVV values are typically embedded in memory or authorization request messages and are not readily known to the user (although they are known to the issuer and payment processors). Payment credentials may be any information that identifies or is associated with a payment account. Payment credentials may be provided in order to make a payment from a payment account. Payment credentials can also include a user name, an expiration date, a gift card number or code, and any other suitable information.

Still referring primarily to FIGS. 1-2, according to the method 200, the issuer system 108 receives 206 a confirmation, from the second user device 110b, of the acceptance of the transfer of the at least one repayment obligation. In other embodiments, the issuer system 108 may transmit or push an additional request to the second user device 110b, based on the receipt 206 of the confirmation. For example, if the initial confirmation request, pushed 204 by the issuer system 108, did not include an option to select and/or modify payment plan details associated with satisfying the at least one repayment obligation, or if the confirmation, received 206 by the issuer system 108, did not include a payment plan detail selection, the issuer system 108 may transmit or push a secondary request, to the second user device 110b, for the second user to select and/or confirm a repayment schedule.

Still referring primarily to FIGS. 1-2, according to the method 200, the issuer system 108 may update 208 a payment plan status associated with the payment plan. In various aspects, the issuer system 108 may update 208 the payment plan status to a transferred status based on the issuer system 108 receiving 206 the confirmation from the second user device 110b. The update 208 may include sending, by the issuer system 108, a payment plan update request to the payment network system 106. In some aspects, the payment plan update request, sent by the issuer system 108, may include an update to data, previously stored within the payment network system 106, representing a status and/or repayment balance of a preexisting payment plan and/or a generation of new data representing a new payment plan and details thereof, associated with the second user, to be stored in the payment network system 106 for satisfying at least one repayment obligation of the preexisting payment plan. In certain aspects, the payment network system 106 may update and/or replace a stored modular credential, previously linked to the payment obligation of the first user, to reflect the details of the new payment plan including an account identifier associated with the second user.

Further to the above, the issuer system 108 may send an indication of the transferred status to the first user device 110a and/or send updated payment plan details associated with a new payment plan to the second user device 110b.

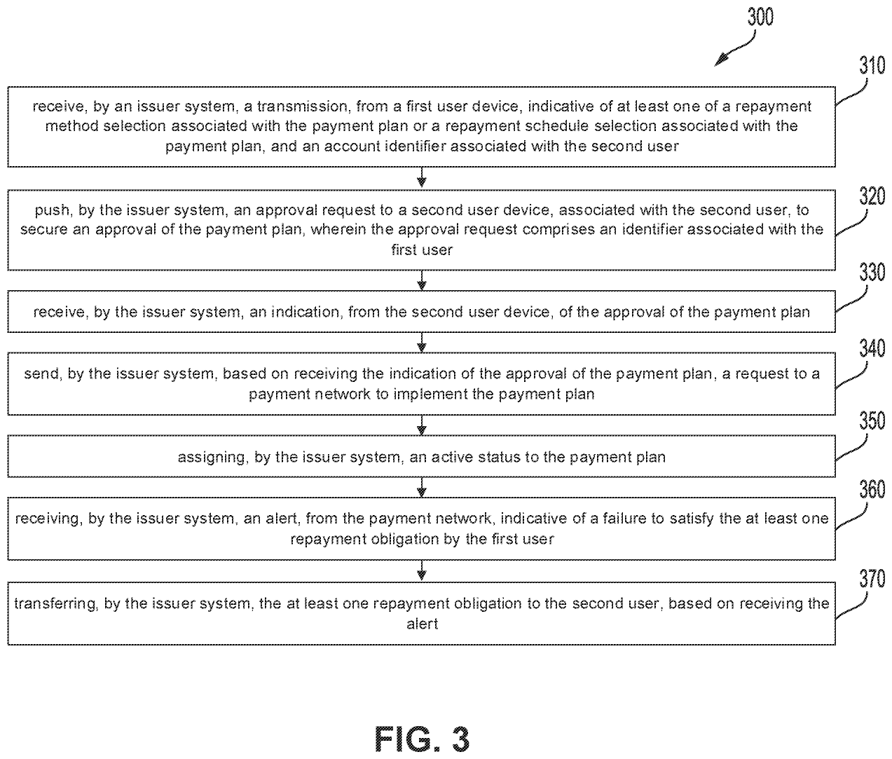

FIG. 3 is a flow diagram of a method 300 for securely transferring at least one repayment obligation associated with a payment plan set for a first user to a second user, according to at least one aspect of the present disclosure. In various aspects, the method 300 may be implemented prior to activating a payment plan, such as a BNPL plan, via an issuer provided API. The method 300 can be executed by the issuer system 108 described above with respect to FIG. 1. To better describe various aspects of the method 300, an illustrative example of the inputs received and outputs generated by the issuer system 108 in the method 300 are discussed below. The method 300 is not limited to these example inputs and outputs.

Referring primarily to FIGS. 1 and 3, according to the method 300, the issuer system 108 receives 310 a transmission from a first user device 110a associated with the first user. In various aspects, the transmission is indicative of at least one of a repayment method selection associated with a payment plan or a repayment schedule selection associated with the payment plan, and an account identifier associated with the second user, such as an issuer platform user name associated with the second user. In some aspects, the repayment method selection may include an account credential associated with the first user. In certain aspects, the transmission received by the issuer system 108 may be a confirmation of a prequalified loan offer previously sent, by the issuer system 108, to the first user via a transmission to the first user device 110a.

Still referring primarily to FIGS. 1 and 3, according to the method 300, the issuer system 108, pushes 320 an approval request to a second user device 110b, associated with the second user, to secure an approval of the payment plan. The approval request includes an identifier associated with the first user. In some aspects, the approval request may include an option to participate in repayment as a secondary option as discussed in further detail below.

Still referring primarily to FIGS. 1 and 3, according to the method 300, the issuer system 108 receives 330 an indication, from the second user device 110b, of the approval of the payment plan. In some aspects, the indication received by the issuer system 108 may trigger a payment plan status update to a created status.

Still referring primarily to FIGS. 1 and 3, according to the method 300, the issuer system 108, based on receiving the indication of the approval of the payment plan, sends 340 a request to a payment network system 106 to implement the payment plan. In various aspects, the payment plan and details thereof are stored in the payment network system 106. In some aspects, the implementation of the payment plan may include receiving, by the issuer system 108, a credential generated by the payment network system 104 and linked within the payment network system 104 to the payment plan. Upon receiving the credential, the issuer system 108 may provide the credential to the first user, thereby allowing the first user to initiate a purchase from a merchant. In some aspects, the credential may be provided as a virtual credential transmitted to the first user device 110a via the issuer API.

Still referring primarily to FIGS. 1 and 3, according to the method 300, the issuer system 108 assigns 350 an active status to the payment plan. In various aspects, the assigning 350 by the issuer system 108 may be triggered upon receiving, by the issuer system 108, an authorization request, sent by an acquirer system 104 associated with a merchant, to complete a payment transaction between the first user and the merchant using the modular credential. Upon assigning 350 an active status to the payment plan, the issuer system 108 may receive, via the payment network server 104, repayments from the first user and/or the second user. Each successful repayment collection may update data stored in the payment network server 104 associated with the payment plan, including a unique transaction identifier associated with successful repayment.

Still referring primarily to FIGS. 1 and 3, according to the method 300, the issuer system 108 receives 360 an alert, from the payment network server 104, indicative of a failure to satisfy the at least one repayment obligation by the first user. In some aspects, the alert may be received 360 by the issuer system 108 following more than one unsuccessful repayment. For example, the payment network may trigger a repayment authorization request using the repayment source associated with the first user, based on the repayment schedule of the payment plan. If the initial repayment authorization request is unsuccessful at collecting a repayment, and a subsequent repayment authorization request also does not result in a repayment collection, the payment network server 104 may then alert the issuer system 108. In certain aspects, the payment network system 106 may attempt to collect a repayment using the account credentials associated with the second user prior to sending the alert to the issuer system 108.

An “authorization request” or “authorization request message” may be an electronic message that is sent to a payment processing network and/or an issuer of a payment account to request authorization for a payment transaction. An authorization request message according to some embodiments may comply with International Organization for Standardisation (ISO) 8583, which is a standard for systems that exchange electronic transaction information associated with a payment made by a consumer using a payment device or a payment account. An ISO 8583 message includes a message type indicator, one or more bitmaps indicating which data elements are present in the message, and data elements of the message. The authorization request message may include an issuer account identifier that may be associated with a payment device or payment account. An authorization request message may be generated by an acceptance device or a server and may be sent to an issuing financial institution directly or through a payment network. In some embodiments of the invention, an authorization request message may include a payment token, an expiration date, a token presentment mode, a token requestor identifier, a token cryptogram, a token assurance level, and data used to generate the token assurance level. The payment token may include a payment token issuer identifier that may be a substitute for a real issuer identifier for an issuer. For example, the real issuer identifier may be part of a BIN range associated with the issuer. An authorization request message may also comprise additional data elements corresponding to “identification information” including, for example, a service code, a CVV or CVC (card verification value or code), a dCVV or dCVC (dynamic card verification value or code), token cryptogram, an expiration date, etc. An authorization request message may also comprise “transaction information,” such as any information associated with a current transaction (e.g. the transaction amount, merchant identifier, merchant location, etc.) as well as any other information that may be utilized in determining whether to identify and/or authorize a payment transaction.

Still referring primarily to FIGS. 1 and 3, according to the method 300, the issuer system 108 may transfer 370 the at least one repayment obligation to the second user, based on receiving the alert. In various aspects, the issuer system 108 may send a request to the payment network system 106 to update the details stored in the payment network system 106 associated with the payment plan to reflect a transfer of the at least one repayment obligation to the second user. In some aspects, the issuer system 108 may automatically transfer the at least one repayment obligation to the second user, based on receiving 360 the alert.

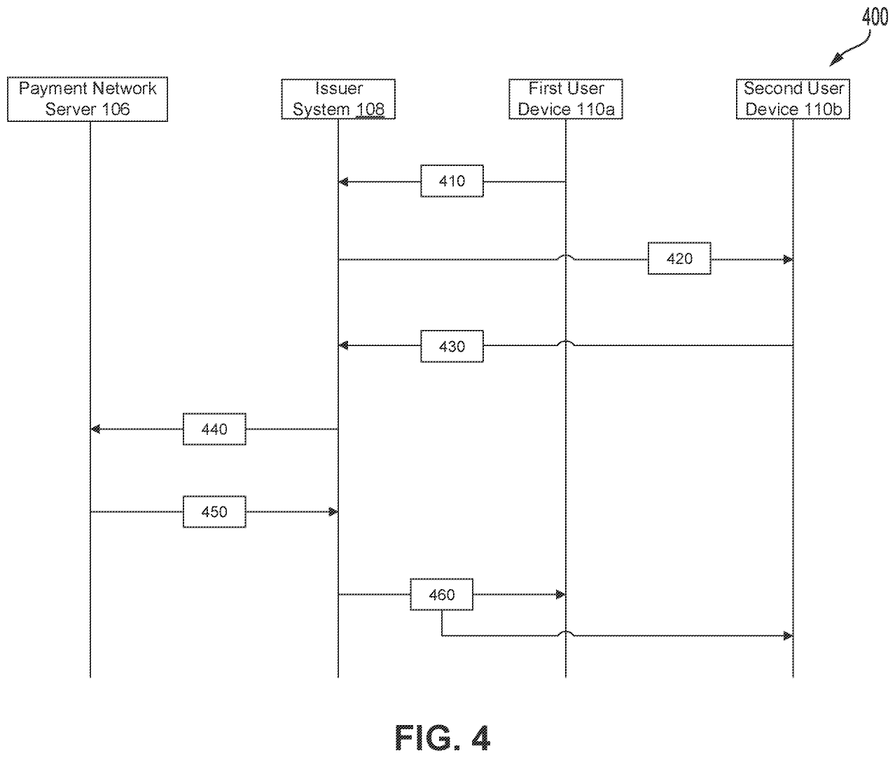

FIG. 4 is a swimlane diagram illustrating a method 400 for securely distributing at least one repayment obligation associated with a payment plan between multiple users, according to at least one aspect of the present disclosure. In some aspects, the method 400 may be implemented prior to generating a payment plan, such as a BNPL plan, via an issuer provided API. The method 400 can be executed by the issuer system 108 described above with respect to FIG. 1. To better describe various aspects of the method 400, an illustrative example of the inputs received and outputs generated by the issuer system 108 in the method 400, with respect to a payment plan set up for two users, are discussed below. The method 400 is not limited to these example inputs and outputs or to a two user setup.

Referring primarily to FIGS. 1 and 4, according to the method 400, the issuer system 108 receives 410 a transmission from a first user device 110a associated with the first user. In various aspects, the transmission is indicative of a set of repayment details associated with the payment plan, and an account identifier associated with a second user. The set of repayment details may include a repayment schedule, a repayment method selection associated with the first user and/or a repayment collection scheme. For example, a repayment collection scheme may define a distribution of funds pulled by, for example, the payment network system 104, using account identifiers associated with each user participating in the payment plan, to satisfy a repayment obligation. In one example, the set of repayment details may require each of the participating users to equally contribute to a repayment obligation, independent of the transaction and/or purchase details associated with a repayment balance. In certain aspects, the transmission is indicative of one or more account identifiers, each associated with a respective user of one or more second users. In the context of a payment plan, a “repayment balance” may refer to a ledger, stored on a server or storage medium of a payment network system 106 and/or an issuer system 108, which accumulates based on completed purchases using credentials associated with the payment plan and/or other charges to users, such as interest and/or payment penalties defined by the set of repayment details. Additionally, a successful repayment may be recorded by the payment network system 108 and decrease the repayment balance accordingly.

Still referring primarily to FIGS. 1 and 4, according to the method 400, the issuer system 108, pushes 420 an acceptance request to a second user device 110b, associated with the second user, to secure an acceptance by the second user to participate in the payment plan, and the set of repayment details associated therewith. In various aspects, the acceptance request includes the set of repayment details indicated in the transmission received 410 by the issuer system 108. In certain aspects, the acceptance request may include an option to select and/or modify the set of repayment details indicated in the transmission received 410, by the issuer system 108.

Still referring primarily to FIGS. 1 and 4, according to the method 400, the issuer system 108 receives 430 a confirmation, from the second user device 110b, indicative of the acceptance, by the second user, to participate in the payment plan. In some aspects, the indication received by the issuer system 108 may trigger a transmission, by the issuer system 108, to the first user device 110a, indicative of changes made to the set of repayment details.

Still referring primarily to FIGS. 1 and 4, according to the method 400, the issuer system 108, based on receiving the confirmation from the second user device, sends 440 a request to a payment network system 104 to generate a payment plan identifier, associated with the payment plan, and a first credential associated with the payment plan identifier. In various aspects, the payment network system 104 is sent 440 a request to generate modular credentials. In some aspects, the request sent 440, by the issuer system 108, to the payment network system 104 may include a request to generate a second credential associated with the payment plan identifier. In certain aspects, the payment plan identifier may be associated with a repayment balance.

As used herein, the term “modular credential” may be defined as a credential which, when used to complete a purchase, such as, for example, by a user device with a merchant device, contributes to an account balance, such as a payment plan balance. When repayment details associated with an account balance are linked to multiple user identifiers, each of the users associated therewith may share the burden of satisfying a repayment obligation until the account balance is paid off. Further, in some examples, more than one modular credential may be associated with a common account balance. Thus, multiple users may employ a respective modular credential to complete separate purchases, each of which may contribute to an account balance common to the multiple users.

Still referring primarily to FIGS. 1 and 4, according to the method 400, the issuer system 108 receives 450 the first credential from the payment network system 106 and sends 460 the first credential to the first user device 110a. In some aspects, the issuer system 108 may send 460 the first credential only to the first user device 110a. In certain examples, the issuer system 108 may additionally receive 450 a second credential from the payment network system 106 and additionally send 460 the second credential to the second user device 110b.

Further to the above, the issuer system 108 may receive a repayment satisfying the at least one repayment obligation, based on an authorization, by the issuer system 108, to complete a purchase using the first credential. In various aspects, the repayment includes portions pulled from accounts associated with the first user and the second user. The relative amounts of the portions associated with the users may be based on a predetermined distribution defined by the set of repayment details received 410 by the issuer system 108. Further, the issuer system 108 may receive the repayment irrespective of transaction details associated with the purchase. For example, a repayment balance, based on a purchase authorized by the issuer system 108 and initiated with the first credential on the first user device 110a, may be shared among the first user and the second user based on the previously defined repayment details. In other examples where multiple credentials were sent 460 by the issuer system 108, any purchases, authorized by the issuer 108 and made using either of the credentials, may contribute to a common repayment balance, to which each repayment made is shared among the first and second users.

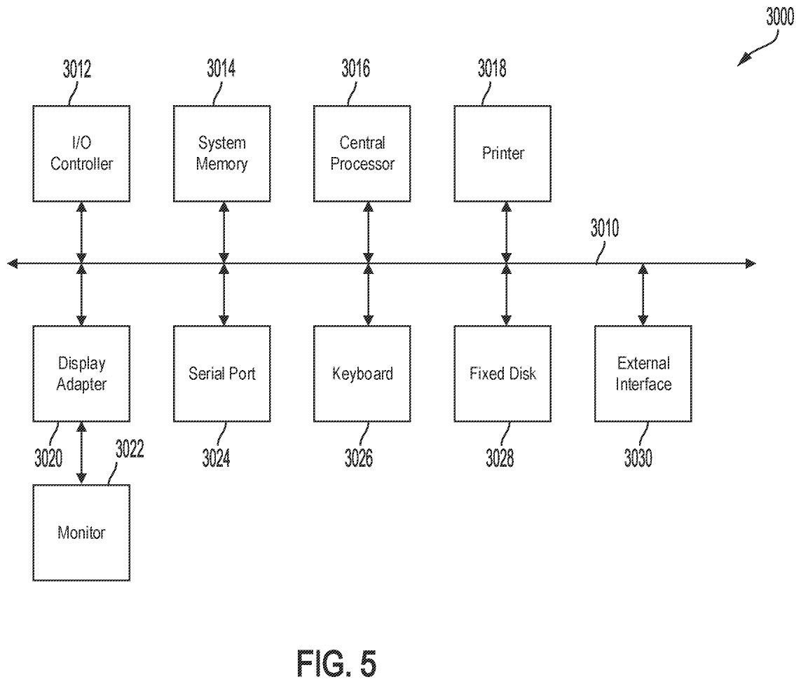

FIG. 5 is a block diagram of a computer apparatus 3000 with data processing subsystems or components, according to at least one aspect of the present disclosure. In some aspects, the computer apparatus 3000 can be the any of the user devices 110, and/or a system 104, 106 and/or 108, described above with respect to FIG. 1. The subsystems shown in FIG. 5 are interconnected via a system bus 3010. Additional subsystems such as a printer 3018, keyboard 3026, fixed disk 3028 (or other memory comprising computer readable media), monitor 3022, which is coupled to a display adapter 3020, and others are shown. Peripherals and input/output (I/O) devices, which couple to an I/O controller 3012 (which can be a processor or other suitable controller), can be connected to the computer system by any number of means known in the art, such as a serial port 3024. For example, the serial port 3024 or external interface 3030 can be used to connect the computer apparatus to a wide area network such as the Internet, a mouse input device, or a scanner. The interconnection via system bus allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer readable medium.

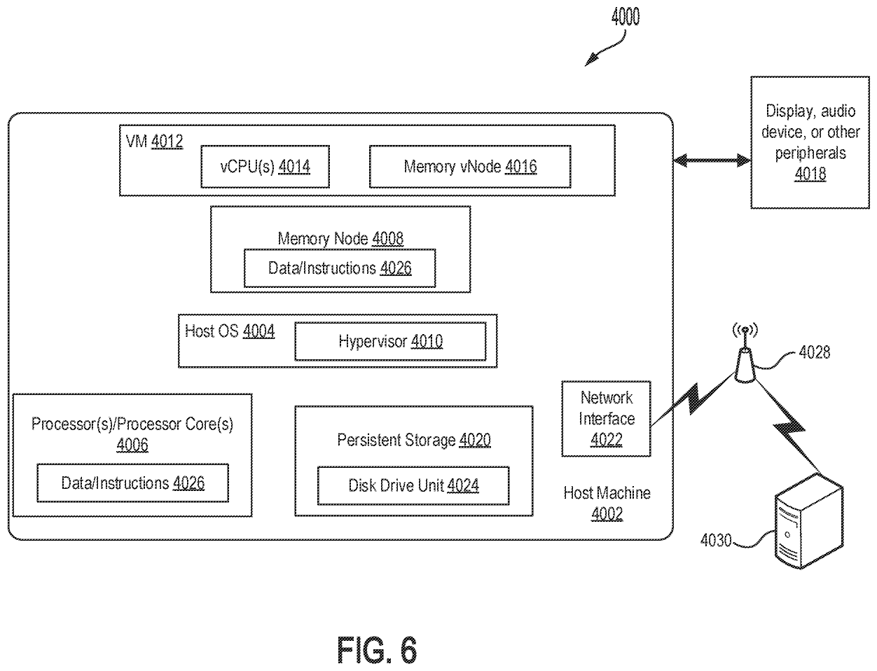

FIG. 6 is a diagrammatic representation of an example system 4000 that includes a host machine 4002 within which a set of instructions to perform any one or more of the methodologies discussed herein may be executed, according to at least one aspect of the present disclosure. In various aspects, the host machine 4002 operates as a standalone device or may be connected (e.g., networked) to other machines. In a networked deployment, the host machine 4002 may operate in the capacity of a server or a client machine in a server-client network environment, or as a peer machine in a peer-to-peer (or distributed) network environment. The host machine 4002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (“VM”) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to the corresponding vNode 4016.

All the various components shown in host machine 4002 may be connected with and to each other, or communicate to each other via a bus (not shown) or via other coupling or communication channels or mechanisms. The host machine 4002 may further include a video display, audio device or other peripherals 4018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 4020 (also referred to as disk drive unit), and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the system 4000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AlN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 4028 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object-oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the method according to various aspects of the present disclosure are provided below in the following numbered clauses. An aspect of the method may include any one or more than one, and any combination of, the numbered clauses described below.
Clause 1. A computer implemented method of securely transferring at least one repayment obligation associated with a payment plan set for a first user to a second user is provided. The method includes receiving, by an issuer system, a transfer request from a first user device, associated with the first user, to transfer the at least one repayment obligation to the second user, wherein the transfer request comprises a payment plan account identifier associated with the second user. The method further includes pushing, by the issuer system, a confirmation request to a second user device, associated with the second user, to confirm acceptance of a transfer of the at least one repayment obligation, wherein the confirmation request comprises an identifier associated with the first user. The method further includes receiving, by the issuer system, a confirmation, from the second user device, of the acceptance of the transfer of the at least one repayment obligation, and updating, by the issuer system, a payment status associated with the payment plan to a transferred status.
Clause 2. The computer implemented method of Clause 1, wherein the confirmation comprises a selection associated with satisfying the at least one repayment obligation by the second user.
Clause 3. The computer implemented method of Clause 2, wherein the selection comprises a repayment schedule.
Clause 4. The computer implemented method of Clause 1, further comprising sending, by the issuer system, a request, to the second user device, to select a repayment schedule, based on receiving the confirmation of the acceptance of the transfer of the at least one repayment obligation.
Clause 5. The computer implemented method of Clause 1, further comprising sending, by the issuer system, an indication, to the first user device, of the transferred status of the payment plan.
Clause 6. The computer implemented method of Clause 1, wherein the payment plan is a buy now pay later (BNPL) payment plan.
Clause 7. A computer implemented method of securely transferring at least one repayment obligation associated with a payment plan set for a first user to a second user is provided. The method includes receiving, by an issuer system, a transmission, from a first user device, indicative of at least one of a repayment method selection associated with the payment plan or a repayment schedule selection associated with the payment plan, and an account identifier associated with the second user. The method further includes pushing, by the issuer system, an approval request to a second user device, associated with the second user, to secure an approval of the payment plan, wherein the approval request comprises an account identifier associated with the first user. The method further includes receiving, by the issuer system, an indication, from the second user device, of the approval of the payment plan, and sending, by the issuer system, based on receiving the indication of the approval of the payment plan, a request to a payment network to implement the payment plan. The method further includes assigning, by the issuer system, an active status to the payment plan, receiving, by the issuer system, an alert, from the payment network, indicative of a failure to satisfy the at least one repayment obligation by the first user, and transferring, by the issuer system, the at least one repayment obligation to the second user, based on receiving the alert.
Clause 8. The computer implemented method of Clause 7, wherein the transmission is a response to a prequalified loan offer sent, by the issuer system, to the first user device.
Clause 9. The computer implemented method of Clause 7, wherein the repayment method selection is a repayment source configured to be automatically pulled from by the payment network.
Clause 10. The computer implemented method of Clause 7, wherein each of the account identifiers associated with the first user and the second user is an account identifier specific to a platform provided by the issuer system.
Clause 11. The computer implemented method of clause 7, further comprising, receiving, by the issuer system, a credential, from the payment network, associated with the payment plan.
Clause 12. The computer implemented method of clause 11, further comprising, transmitting, by the issuer system, the credential to the first user device.
Clause 13. The computer implemented method of clause 7, wherein the issuer system automatically transfers the at least one repayment obligation to the second user, based on receiving the alert.
Clause 14. A computer implemented method of securely distributing at least one repayment obligation associated with a payment plan between multiple users is provides. The method includes receiving, by an issuer system, a transmission, from a first user device, indicative of a set of repayment details associated with the payment plan, and an account identifier associated with a second user. The method further includes pushing, by the issuer system, an acceptance request to a second user device, associated with the second user, to secure an acceptance by the second user to participate in the payment plan, and the set of repayment details associated therewith. The method further includes receiving, by the issuer system, a confirmation, from the second user device, indicative of the acceptance, by the second user, to participate in the payment plan. The method further includes sending, by the issuer system, based on receiving the confirmation from the second user device, a request to a payment network to generate a payment plan identifier associated with the payment plan and a first credential associated with the payment plan identifier, receiving, by the issuer system, the first credential from the payment network, and sending, by the issuer system, the first credential to the first user device.
Clause 15. The computer implemented method of clause 14, further comprising:
receiving, by the issuer system, a repayment satisfying the at least one repayment obligation, based on an authorization, by the issuer system, to complete a purchase using the first credential, wherein the repayment comprises portions pulled from accounts associated with the first user and the second user.
Clause 16. The computer implemented method of Clause 15, wherein the first credential is sent, by the issuer system, to only the first user device
Clause 17. The computer implemented method of clause 16, further comprising:
sending, by the issuer system, based on receiving the indication of the acceptance from the second user device, a request to the payment network to generate a second credential associated with the payment plan identifier and the account identifier associated with the second user.
Clause 18. The computer implemented method of Clause 17, further comprising:
receiving, by the issuer system, the second credential from the payment network; and sending, by the issuer system, the second credential to the second user device.
Clause 19. The computer implemented method of Clause 17, further comprising:
receiving, by the issuer system, a repayment satisfying the at least one repayment obligation, wherein the repayment obligation comprises a portion of a common payment plan balance associated with the first credential and the second credential.
Clause 20. The computer implemented method of Clause 14, further comprising: pushing, by the issuer system, an acceptance request to a third user device, associated with a third user, to secure an acceptance by the third user to participate in the payment plan, and the set of repayment details associated therewith.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an embodiment or aspect, but other elements may be added and still form a construct within the scope of a claim. In contrast, the transitional phrase “consisting of” excludes any element, step, or ingredient not specified in a claim. This is consistent with the use of the term throughout the specification.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A computer implemented method of securely transferring at least one repayment obligation associated with a payment plan set for a first user to a second user, the method comprising:
receiving, by an issuer system, a transfer request from a first user device, associated with the first user, to transfer the at least one repayment obligation to the second user, wherein the transfer request comprises a payment plan account identifier associated with the second user;
pushing, by the issuer system, a confirmation request to a second user device, associated with the second user, to confirm acceptance of a transfer of the at least one repayment obligation, wherein the confirmation request comprises an identifier associated with the first user;
receiving, by the issuer system, a confirmation, from the second user device, of the acceptance of the transfer of the at least one repayment obligation; and
updating, by the issuer system, a payment status associated with the payment plan to a transferred status.

2. The computer implemented method of claim 1, wherein the confirmation comprises a selection associated with satisfying the at least one repayment obligation by the second user.

3. The computer implemented method of claim 2, wherein the selection comprises a repayment schedule.

4. The computer implemented method of claim 1, further comprising sending, by the issuer system, a request, to the second user device, to select a repayment schedule, based on receiving the confirmation of the acceptance of the transfer of the at least one repayment obligation.

5. The computer implemented method of claim 1, further comprising sending, by the issuer system, an indication, to the first user device, of the transferred status of the payment plan.

6. The computer implemented method of claim 1, wherein the payment plan is a buy now pay later (BNPL) payment plan.

7. A computer implemented method of securely transferring at least one repayment obligation associated with a payment plan set for a first user to a second user, the method comprising:
receiving, by an issuer system, a transmission, from a first user device, indicative of at least one of a repayment method selection associated with the payment plan or a repayment schedule selection associated with the payment plan, and an account identifier associated with the second user;
pushing, by the issuer system, an approval request to a second user device, associated with the second user, to secure an approval of the payment plan, wherein the approval request comprises an account identifier associated with the first user;
receiving, by the issuer system, an indication, from the second user device, of the approval of the payment plan;
sending, by the issuer system, based on receiving the indication of the approval of the payment plan, a request to a payment network to implement the payment plan;
assigning, by the issuer system, an active status to the payment plan;
receiving, by the issuer system, an alert, from the payment network, indicative of a failure to satisfy the at least one repayment obligation by the first user; and
transferring, by the issuer system, the at least one repayment obligation to the second user, based on receiving the alert.

8. The computer implemented method of claim 7, wherein the transmission is a response to a prequalified loan offer sent, by the issuer system, to the first user device.

9. The computer implemented method of claim 7, wherein the repayment method selection is a repayment source configured to be automatically pulled from by the payment network.

10. The computer implemented method of claim 7, wherein each of the account identifiers associated with the first user and the second user is an account identifier specific to a platform provided by the issuer system.

11. The computer implemented method of claim 7, further comprising, receiving, by the issuer system, a credential, from the payment network, associated with the payment plan.

12. The computer implemented method of claim 11, further comprising, transmitting, by the issuer system, the credential to the first user device.

13. The computer implemented method of claim 7, wherein the issuer system automatically transfers the at least one repayment obligation to the second user, based on receiving the alert.

14. A computer implemented method of securely distributing at least one repayment obligation associated with a payment plan between multiple users, the method comprising:
receiving, by an issuer system, a transmission, from a first user device, indicative of a set of repayment details associated with the payment plan, and an account identifier associated with a second user;
pushing, by the issuer system, an acceptance request to a second user device, associated with the second user, to secure an acceptance by the second user to participate in the payment plan, and the set of repayment details associated therewith;
receiving, by the issuer system, a confirmation, from the second user device, indicative of the acceptance, by the second user, to participate in the payment plan;
sending, by the issuer system, based on receiving the confirmation from the second user device, a request to a payment network to generate a payment plan identifier associated with the payment plan and a first credential associated with the payment plan identifier;
receiving, by the issuer system, the first credential from the payment network; and
sending, by the issuer system, the first credential to the first user device.

15. The computer implemented method of claim 14, further comprising:
receiving, by the issuer system, a repayment satisfying the at least one repayment obligation, based on an authorization, by the issuer system, to complete a purchase using the first credential, wherein the repayment comprises portions pulled from accounts associated with the first user and the second user.

16. The computer implemented method of claim 15, wherein the first credential is sent, by the issuer system, to only the first user device.

17. The computer implemented method of claim 16, further comprising:
sending, by the issuer system, based on receiving the indication of the acceptance from the second user device, a request to the payment network to generate a second credential associated with the payment plan identifier and the account identifier associated with the second user.

18. The computer implemented method of claim 17, further comprising:
receiving, by the issuer system, the second credential from the payment network; and
sending, by the issuer system, the second credential to the second user device.

19. The computer implemented method of claim 17, further comprising:
receiving, by the issuer system, a repayment satisfying the at least one repayment obligation, wherein the repayment obligation comprises a portion of a common payment plan balance associated with the first credential and the second credential.

20. The computer implemented method of claim 14, further comprising:
pushing, by the issuer system, an acceptance request to a third user device, associated with a third user, to secure an acceptance by the third user to participate in the payment plan, and the set of repayment details associated therewith.
